(19) United States
(12) Patent Application Publication
(10) Pub. No.: US 2026/0211831 A1
(43) Pub. Date: Jul. 23, 2026

(54) PROVIDING FLEXIBLE LINK WIDTH (FLW) DUAL 32-BIT (x32) LINKS IN UNIVERSAL CHIPLET INTERCONNECT EXPRESS (UCIe) 64-BIT (x64) MODULES IN PROCESSOR-BASED DEVICES

(71) Applicant: QUALCOMM Incorporated, San Diego, CA (US)

(72) Inventors: Santhosh Reddy Akavaram, Hyderabad (IN); Sridhar Anumala, Hyderabad (IN); Sang Tran, Encinitas, CA (US); Sivaiah Gopavaram, Bangalore (IN); Ravindranath Doddi, Hyderabad (IN); Ramacharan Sundararaman, San Jose, CA (US)

(21) Appl. No.: 19/034,813

(22) Filed: Jan. 23, 2025

(51) Int. Cl. G06F 13/42; G06F 13/38

(52) U.S. Cl. CPC G06F 13/4221; G06F 13/382

(57) ABSTRACT

Providing Flexible Link Width (FLW) dual 32-bit (x32) links in Universal Chiplet Interconnect Express (UCIe) 64-bit (x64) modules in processor-based devices is disclosed herein. In some aspects, a UCIe x64 module establishes a first x32 link with a first UCIe x32 module using mainband transmit signal lanes including a first 32 bits of a mainband data transmit signal lane, mainband receive signal lanes including a first 32 bits of a mainband data receive signal lane, and sideband signal lanes. The UCIe x64 module also establishes a second x32 link with a second UCIe x32 module using a second 32 bits of the mainband data transmit signal lane, a second 32 bits of the mainband data receive signal lane, redundant mainband transmit signal lanes, redundant mainband receive signal lanes, and redundant sideband signal lanes. The UCIe x64 module then establishes data transfer via the first and the second x32 links.

### TECHNICAL FIELD

The technology of the disclosure relates generally to the use of Universal Chiplet Interconnect Express (UCIe) protocol in processor-based devices, and, in particular, to facilitating data transfer between a single UCIe 64-bit (x64) module and two (2) UCIe 32-bit (x32) modules.

### BACKGROUND

The Universal Chiplet Interconnect Express (UCIe) protocol is an open specification for die-to-die interconnects and serial buses between “chiplets,” or small modular integrated circuit components associated with specific functionalities within processor-based devices. The UCIe protocol is designed for communication between chiplets within a single package, and offers a flexible and efficient way to connect different types of chiplets, such as central processing units (CPUs), graphics processing units (GPUs), artificial intelligence (AI) accelerators, and memory controllers, as non-limiting examples.

Revision 2.0, Version 1.0 of the UCIe protocol defines a specification for a 64-bit (x64) advanced package module that is configured to provide mainband and sideband signal lanes, along with corresponding redundant mainband and sideband signal lanes, for communications between chiplets. Such UCIe x64 modules are capable of establishing x64 data links with other UCIe x64 modules, and are also capable of interoperating with UCIe 32-bit (x32) modules using a width reduction configuration. When using the width reduction configuration, 32 of the 64 mainband transmit and receive signal lanes and two (2) of the redundant mainband signal lanes that are normally used by a UCIe x64 module to establish an x64 data link are rendered unusable.

While the conventional width reduction configuration enables the UCIe x64 module to communicate with a wider range of modules, there are some disadvantages to its use in particular scenarios. For example, consider a scenario in which a processor-based device requires multiple (e.g., two (2)) UCIe x32 data links with a UCIe x64 module. The UCIe protocol as it presently exists does not support a configuration in which two (2) UCIe x32 links can be established with a single UCIe x64 module using single-module configuration. Instead, accommodating the requirements of two (2) UCIe x32 links requires the deployment of two (2) UCIe x64 modules. As a result, up to 32 bits of data transfer capability are wasted by each of the UCIe x64 modules, and additional physical space on the hardware circuit board is consumed by the extra UCIe x64 module.

Accordingly, it is desirable to provide a mechanism to efficiently support dual x32 links in a single UCIe x64 module.

### SUMMARY OF THE DISCLOSURE

Aspects disclosed in the detailed description include providing Flexible Link Width (FLW) dual 32-bit (x32) links in Universal Chiplet Interconnect Express (UCIe) 64-bit (x64) modules in processor-based devices. Related apparatus, methods, and computer-readable media are also disclosed. In this regard, in some exemplary aspects disclosed herein, a processor-based device, such as a UCIe multi-die Advanced Package module, comprises a UCIe x64 module that is configured to support dual x32 links with a corresponding first and second UCIe x32 modules. In exemplary operation, the UCIe x64 module determines, during initialization of the processor-based device, that the UCIe x64 module supports FLW (e.g., by determining that an FLW module configuration bit in a Device Vendor Specific Extended Capabilities (DVSEC) Link Capability register of the processor-based device is set, and/or by determining that an FLW module configuration bit in a physical layer (PHY) control register of the processor-based device is set). In some aspects, in response to determining that the UCIe x64 module supports FLW, the UCIe x64 module sets an FLW indication of an MBINIT. PARAM message that is transmitted to other modules during the initialization to indicate support for FLW.

In response to determining that the UCIe x64 module supports FLW, the UCIe x64 module determines during the initialization of the processor-based device that the UCIe x64 module is communicatively coupled to a first UCIe x32 module and a second UCIe x32 module that require a first x32 link and a second x32 link, respectively. This determination may take place, e.g., during link training. In response to determining that the UCIe x64 module is communicatively coupled to the first UCIe x32 module and the second UCIe x32 module, the UCIe x64 module performs a series of operations. In some aspects, the UCIe x64 module updates the DVSEC Link Capability register of the processor-based device to indicate a count of active modules, a configuration of each active module, and a count of die-to-die stacks required to support links between the UCIe x64 module and the first and second UCIe x32 modules. The UCIe x64 module may also configure a first die-to-die stack and a second die-to-die stack corresponding to the first UCIe x32 module and the second UCIe x32 module, respectively.

The UCIe x64 module next establishes the first x32 link with the first UCIe x32 module. The first x32 link is established using a plurality of mainband transmit signal lanes including a first 32 bits of a mainband data transmit signal lane, a plurality of mainband receive signal lanes including a first 32 bits of a mainband data receive signal lane, and a plurality of sideband signal lanes. The UCIe x64 module also establishes the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes. The UCIe x64module then establishes data transfer via the first x32 link and the second x32 link. The data transfer may be enabled using a Raw Die-to-Die Interface (RDI) multiplexor of the UCIe x64 module that is configured to arbitrate data transmitted via the first and the second x32 links between the first and the second die-to-die stacks, respectively, and a PHY of the UCIe x64 module.

In some aspects, the UCIe x64 module may determine during a second initialization of the processor-based device that the UCIe x64 module is communicatively coupled to a single UCIe x32 module that requires a third x32 link. In response, the UCIe x64 module in such aspects establishes the third x32 link with the single UCIe x32 module using the plurality of mainband transmit signal lanes including the first 32 bits of the mainband data transmit signal lane, the plurality of mainband receive signal lanes including the first 32 bits of the mainband data receive signal lane, and the plurality of sideband signal lanes. The UCIe x64 module then establishes data transfer via the third x32 link.

The UCIe x64 module according to some aspects may determine during a third initialization of the processor-based device that the UCIe x64 module is communicatively coupled to a single UCIe x64 module that requires an x64 link. In response, the UCIe x64 module establishes the x64 link with the single UCIe x64 module using the plurality of mainband transmit signal lanes including all 64 bits of the mainband data transmit signal lane, the plurality of mainband receive signal lanes including all 64 bits of the mainband data receive signal lane, the plurality of sideband signal lanes, the plurality of redundant mainband transmit signal lanes, the plurality of redundant mainband receive signal lanes, and the plurality of redundant sideband signal lanes. The UCIe x64 module then establishes data transfer via the x64 link.

In another aspect, a processor-based device is provided. The processor-based device comprises a UCIe x64 module configured to determine, during a first initialization of the processor-based device, that the UCIe x64 module supports FLW. The UCIe x64 module is further configured to, responsive to determining that the UCIe x64 module supports FLW, determine, during the first initialization of the processor-based device, that the UCIe x64 module is communicatively coupled to a first UCIe x32 module and a second UCIe x32 module that require a first x32 link and a second x32 link, respectively. The UCIe x64 module is also configured to, responsive to determining that the UCIe x64 module is communicatively coupled to the first UCIe x32 module and the second UCIe x32 module, establish the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes. The UCIe x64 module is additionally configured to establish the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes. The UCIe x64 module is further configured to establish data transfer via the first x32 link and the second x32 link.

In another aspect, a processor-based device is provided. The processor-based device comprises means for determining, during a first initialization of the processor-based device, that a UCIe x64 module of the processor-based device supports FLW. The processor further comprises means for determining, during the first initialization of the processor-based device, that the UCIe x64 module is communicatively coupled to a first UCIe x32 module and a second UCIe x32 module that require a first x32 link and a second x32 link, respectively, responsive to determining that the UCIe x64 module supports FLW. The processor also comprises means for establishing the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes, responsive to determining that the UCIe x64 module is communicatively coupled to the first UCIe x32 module and the second UCIe x32 module. The processor-based device additionally comprises means for establishing the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes, responsive to determining that the UCIe x64 module is communicatively coupled to the first UCIe x32 module and the second UCIe x32 module. The processor further comprises means for establishing data transfer via the first x32 link and the second x32 link, responsive to determining that the UCIe x64 module is communicatively coupled to the first UCIe x32 module and the second UCIe x32 module.

In another aspect, a method for providing FLW dual x32 links in UCIe x64 modules in processor-based devices is disclosed. The method comprises determining, by a UCIe x64 module of a processor-based device during a first initialization of the processor-based device, that the UCIe x64 module supports FLW. The method further comprises, responsive to determining that the UCIe x64 module supports FLW, determining, by the UCIe x64 module during the first initialization of the processor-based device, that the UCIe x64 module is communicatively coupled to a first UCIe x32 module and a second UCIe x32 module that require a first x32 link and a second x32 link, respectively. The method also comprises, responsive to determining that the UCIe x64 module is communicatively coupled to the first UCIe x32 module and the second UCIe x32 module, establishing, by the UCIe x64 module, the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes. The method additionally comprises establishing, by the UCIe x64 module, the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes. The method further comprises establishing, by the UCIe x64 module, data transfer via the first x32 link and the second x32 link.

In another aspect, a non-transitory computer-readable medium is disclosed. The non-transitory computer-readable medium stores computer-executable instructions that, when executed by a processor device of a processor-based device, cause a UCIe x64 module of the processor-based device to determine, during a first initialization of the processor-based device, that the UCIe x64 module supports FLW. The computer-executable instructions further cause the UCIe x64 module to, responsive to determining that the UCIe x64 module supports FLW, determine, during the first initialization of the processor-based device, that the UCIe x64 module is communicatively coupled to a first UCIe x32 module and a second UCIe x32 module that require a first x32 link and a second x32 link, respectively. The computer-executable instructions also cause the UCIe x64 module to, responsive to determining that the UCIe x64 module is communicatively coupled to the first UCIe x32 module and the second UCIe x32 module, establish the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes. The computer-executable instructions additionally cause the UCIe x64 module to establish the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes. The computer-executable instructions further cause the UCIe x64 module to establish data transfer via the first x32 link and the second x32 link.

### BRIEF DESCRIPTION OF THE FIGURES

FIG. 1 is a diagram illustrating a conventional Universal Chiplet Interconnect Express (UCIe) 64-bit (x64) module for providing x64 links and reduced-width 32-bit (x32) links with other modules in a processor-based device, according to some aspects;

FIG. 2 provides a chart illustrating a UCIe x64 Advanced Package Module signal list detailing the specific signal lanes that make up the electrical/Analog Front End (AFE) signal lanes, the sideband signal lanes, the redundant electrical/AFE signal lanes, and the redundant sideband signal lanes of the UCIe x64 module of FIG. 1, according to some aspects;

FIG. 3 is a diagram illustrating a UCIe x64 module configured to enable Flexible Link Width (FLW) configurations supporting dual x32 links, according to some aspects;

FIGS. 4A-4B provides charts illustrating how the UCIe x64 module of FIG. 3 uses the mainband signal lanes, the redundant mainband signal lanes, the sideband signal lanes, and the redundant sideband signal lanes of FIG. 2 to provide the dual x32 links of FIG. 3, according to some aspects;

FIG. 5 is a diagram illustrating the UCIe x64 module of FIG. 3 configured to support a single x32 link, according to some aspects;

FIG. 6 is a diagram illustrating the UCIe x64 module of FIG. 3 configured to support a single x64 link, according to some aspects;

FIGS. 7A-7E is a flowchart illustrating exemplary operations performed by the processor-based device of FIG. 3 for providing FLW dual x32 links in UCIe x64 modules, according to some aspects; and

FIG. 8 is a block diagram of an exemplary processor-based device that can include the processor-based device of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like used herein are intended to distinguish between similarly named elements, and do not indicate an ordinal relationship between such elements unless otherwise expressly indicated.

Aspects disclosed in the detailed description include providing Flexible Link Width (FLW) dual 32-bit (x32) links in Universal Chiplet Interconnect Express (UCIe) 64-bit (x64) modules in processor-based devices. Related apparatus, methods, and computer-readable media are also disclosed. In this regard, in some exemplary aspects disclosed herein, a processor-based device, such as a UCIe multi-die Advanced Package module, comprises a UCIe x64 module that is configured to support dual x32 links with a corresponding first and second UCIe x32 modules. In exemplary operation, the UCIe x64 module determines, during initialization of the processor-based device, that the UCIe x64 module supports FLW (e.g., by determining that an FLW module configuration bit in a Device Vendor Specific Extended Capabilities (DVSEC) Link Capability register of the processor-based device is set, and/or by determining that an FLW module configuration bit in a physical layer (PHY) control register of the processor-based device is set). In some aspects, in response to determining that the UCIe x64 module supports FLW, the UCIe x64 module sets an FLW indication of an MBINIT. PARAM message that is transmitted to other modules during the initialization to indicate support for FLW.

In response to determining that the UCIe x64 module supports FLW, the UCIe x64 module determines during the initialization of the processor-based device that the UCIe x64 module is communicatively coupled to a first UCIe x32 module and a second UCIe x32 module that require a first x32 link and a second x32 link, respectively. This determination may take place, e.g., during link training. In response to determining that the UCIe x64 module is communicatively coupled to the first UCIe x32 module and the second UCIe x32 module, the UCIe x64 module performs a series of operations. In some aspects, the UCIe x64 module updates the DVSEC Link Capability register of the processor-based device to indicate a count of active modules, a configuration of each active module, and a count of die-to-die stacks required to support links between the UCIe x64 module and the first and second UCIe x32 modules. The UCIe x64 module may also configure a first die-to-die stack and a second die-to-die stack corresponding to the first UCIe x32 module and the second UCIe x32 module, respectively.

The UCIe x64 module next establishes the first x32 link with the first UCIe x32 module. The first x32 link is established using a plurality of mainband transmit signal lanes including a first 32 bits of a mainband data transmit signal lane, a plurality of mainband receive signal lanes including a first 32 bits of a mainband data receive signal lane, and a plurality of sideband signal lanes. The UCIe x64 module also establishes the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes. The UCIe x64 module then establishes data transfer via the first x32 link and the second x32 link. The data transfer may be enabled using a Raw Die-to-Die Interface (RDI) multiplexor of the UCIe x64 module that is configured to arbitrate data transmitted via the first and the second x32 links between the first and the second die-to-die adapters, respectively, and a PHY of the UCIe x64 module.

In some aspects, the UCIe x64 module may determine during a second initialization of the processor-based device that the UCIe x64 module is communicatively coupled to a single UCIe x32 module that requires a third x32 link. In response, the UCIe x64 module in such aspects establishes the third x32 link with the single UCIe x32 module using the plurality of mainband transmit signal lanes including the first 32 bits of the mainband data transmit signal lane, the plurality of mainband receive signal lanes including the first 32 bits of the mainband data receive signal lane, and the plurality of sideband signal lanes. The UCIe x64 module then establishes data transfer via the third x32 link.

The UCIe x64 module according to some aspects may determine during a third initialization of the processor-based device that the UCIe x64 module is communicatively coupled to a single UCIe x64 module that requires an x64 link. In response, the UCIe x64 module establishes the x64 link with the single UCIe x64 module using the plurality of mainband transmit signal lanes including all 64 bits of the mainband data transmit signal lane, the plurality of mainband receive signal lanes including all 64 bits of the mainband data receive signal lane, the plurality of sideband signal lanes, the plurality of redundant mainband transmit signal lanes, the plurality of redundant mainband receive signal lanes, and the plurality of redundant sideband signal lanes. The UCIe x64 module then establishes data transfer via the x64 link.

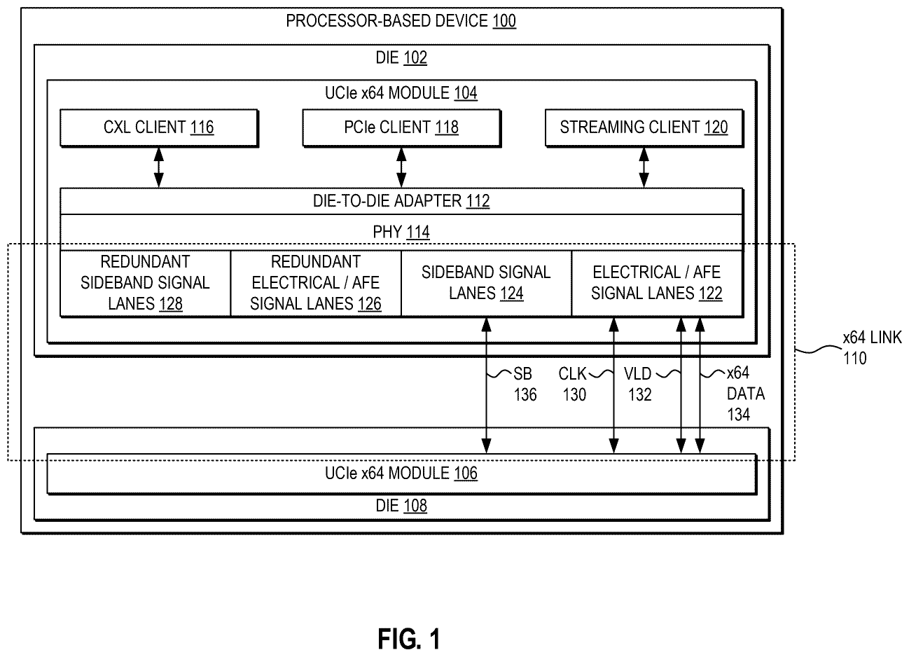

Before discussing aspects of a UCIe x64 module configured to provide FLW dual x32 links as disclosed herein, the elements of and operations performed by a conventional UCIe x64 module for providing x64 links and reduced-width x32 links are first described. In this regard, FIG. 1 is a diagram of an exemplary processor-based device 100 that may comprise, e.g., a UCIe multi-die Advanced Package module. The processor-based device 100 includes a first die 102 that comprises a first UCIe x64 module 104. The UCIe x64 module 104 is communicatively coupled to a second UCIe x64 module 106 of a second die 108 of the processor-based device 100 via an x64 link 110.

The x64 link 110 is managed by a die-to-die adapter 112 and a PHY 114 of the UCIe x64 module 104. The die-to-die adapter 112 comprises circuits configured to act as a bridge between a protocol layer (not shown) of the UCIe x64 module 104 and the PHY 114, and is responsible for link management, protocol selection and negotiation, and data transfer. The die-to-die adapter 112 in the example of FIG. 1 is configured to interface multiple protocols, such as the Compute Express Link (CXL), the Peripheral Component Interconnect Express (PCIe) protocol, and streaming protocols, to the PHY 114. Accordingly, the die-to-die adapter 112 is shown in FIG. 1 manages communications to and from a CXL client 116, a PCIe client 118, and a streaming client 120, each of which comprises a device configured to communicate with the x64 module 106 using their respective protocols.

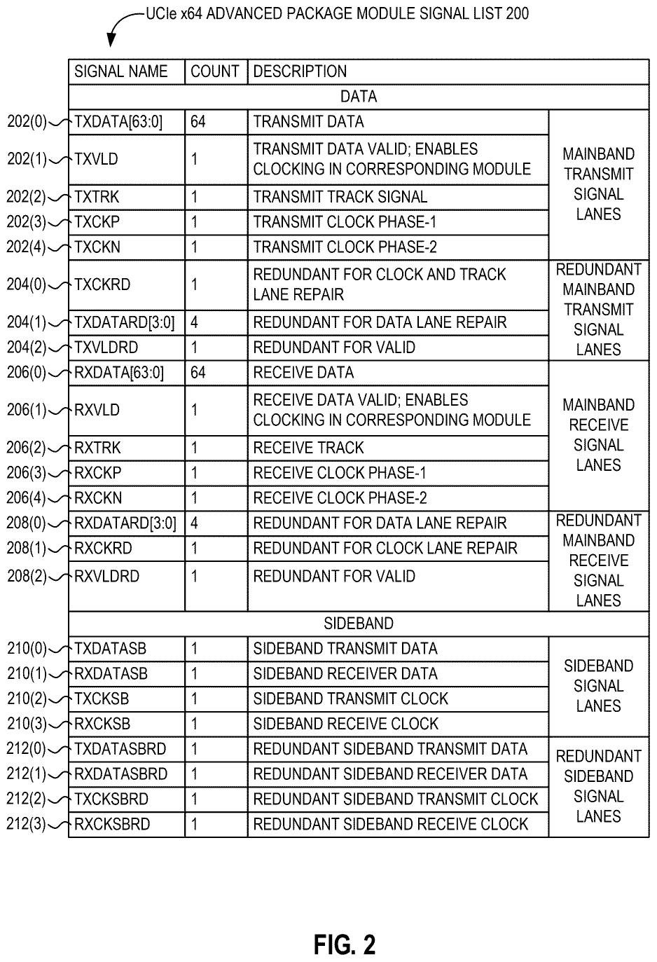

The PHY 114 of the x64 module 104 is responsible for managing the electrical interface and signaling between the die 102 and the die 108. The electrical interface between the die 102 and the die 108 includes multiple signal lanes that are grouped into electrical/Analog Front End (AFE) signal lanes (captioned as “ELECTRICAL/AFE SIGNAL LANES” in FIG. 1) 122, sideband signal lanes 124, redundant electrical/AFE signal lanes 126, and redundant sideband signal lanes 128. As discussed in greater detail below with respect to FIG. 2, the electrical/AFE signal lanes 122 include clock signal lanes (captioned as “CLK” in FIG. 1) 130, data valid signal lanes (captioned as “VLD” in FIG. 1) 132, and 64 data signal lanes (captioned as “x64 DATA” in FIG. 1) 134 in each direction (transmit and receive). The electrical/AFE signal lanes 122 may be collectively referred to as “mainband signal lanes.” The sideband signal lanes 124 include sideband data signal lanes (captioned as “SB” in FIG. 1) 136 that may be used for initialization, link training, and reading and/or writing configuration data. The redundant electrical/AFE signal lanes 126 and the redundant sideband signal lanes 128 provide redundant backup for the electrical/AFE signal lanes 122 and the sideband signal lanes 124, respectively. As seen in FIG. 1, when operating in conventional x64 mode, the x64 link 110 employs only the electrical/AFE signal lanes 122 and the sideband signal lanes 124, and does not use the redundant electrical/AFE signal lanes 126 and the redundant sideband signal lanes 128.

The processor-based device 100 of FIG. 1 and the constituent elements thereof may encompass any one of known digital logic elements, semiconductor circuits, processing cores, and/or memory structures, among other elements, or combinations thereof. Embodiments described herein are not restricted to any particular arrangement of elements, and the disclosed techniques may be easily extended to various structures and layouts on semiconductor sockets or packages. It is to be understood that some embodiments of the processor-based device 100 may include elements in addition to those illustrated in FIG. 1. For example, the processor-based device 100 may further include one or more instruction caches, unified caches, controller circuits, interconnect buses, and/or additional memory devices, caches, and/or controller circuits that are not shown in FIG. 1 for the sake of clarity.

FIG. 2 illustrates in greater detail the specific signal lanes that make up the electrical/AFE signal lanes 122, the sideband signal lanes 124, the redundant electrical/AFE signal lanes 126, and the redundant sideband signal lanes 128 of the UCIe x64 module 104 of FIG. 1. In FIG. 2, a UCIe x64 Advanced Package Module signal list 200 (also referred to herein as the “signal list 200”) is provided. The signal list 200 includes a plurality of mainband transmit signal lanes 202(0)-202(4), a plurality of redundant mainband transmit signal lanes 204(0)-204(2), a plurality of mainband receive signal lanes 206(0)-206(4), a plurality of redundant mainband receive signal lanes 208(0)-208(2), a plurality of sideband signal lanes 210(0)-210(3), and a plurality of redundant sideband signal lanes 212(0)-212(3). The mainband transmit signal lanes 202(0)-202(4) and the mainband receive signal lanes 206(0)-206(4) together correspond to the electrical/AFE signal lanes 122 of FIG. 1, while the redundant mainband transmit signal lanes 204(0)-204(2) and the redundant mainband receive signal lanes 208(0)-208(2) together correspond to the redundant electrical/AFE signal lanes 126 of FIG. 1. Similarly, the sideband signal lanes 210(0)-210(3) correspond to the sideband signal lanes 124 of FIG. 1, while the redundant sideband signal lanes 212(0)-212(3) correspond to the redundant sideband signal lanes 128 of FIG. 1.

It is noted that the mainband transmit signal lane 202(0), with the name TXDATA[63:0], may also be referred to herein as the “mainband data transmit signal lane 202(0),” while the mainband receive signal lane 206(0), with the name RXDATA[63:0], may also be referred to herein as the “mainband data receive signal lane 206(0).” When the UCIe x64 module 104 is configured to operate in conventional UCIe x64 mode, all 64 bits of each of the mainband data transmit signal lane 202(0) and the mainband data receive signal lane 206(0) are used when transmitting to and receiving data from the UCIe x64 module 106.

As discussed above, when the conventional UCIe x64 module 104 of FIG. 1 is operating under a width reduction configuration to communicate with a UCIe x32 module, 32 bits of the mainband data transmit signal lane 202(0) and 32 bits of the mainband data receive signal lane 206(0) go unused, resulting in wasted bandwidth. Moreover, if multiple x32 links are required (e.g., to communicate with multiple UCIe x32 modules), each x32 link requires deployment of a corresponding separate UCIe x64 module, which consumes additional physical space on the underlying hardware circuit board.

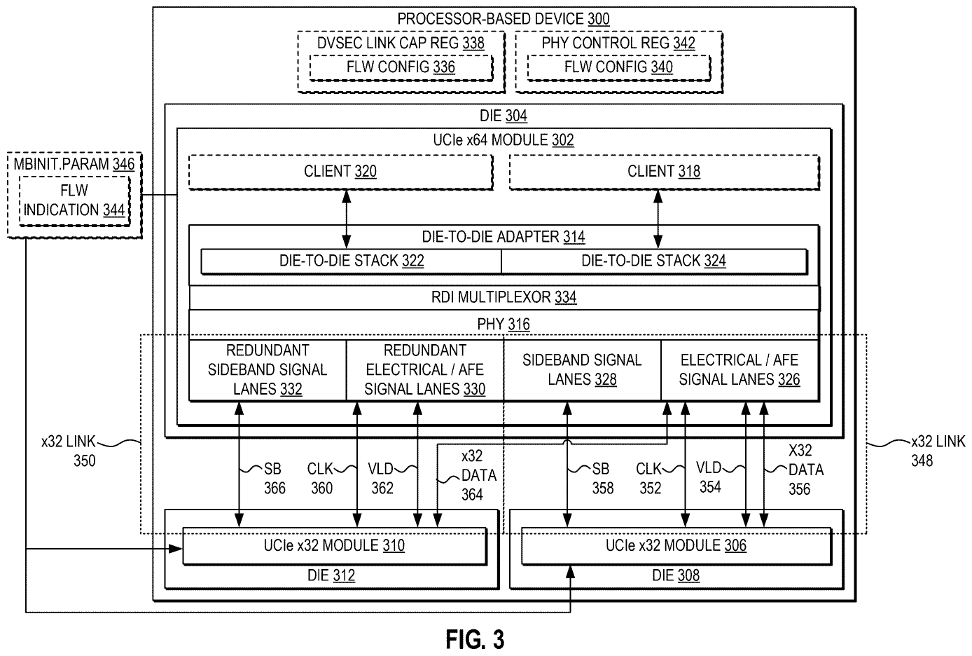

Accordingly, in this regard, FIG. 3 illustrates a processor-based device 300 that comprises a UCIe x64 module 302 configure to support an FLW mode that provides dual x32 links using single-module configuration. The UCIe x64 module 302, located on a first die 304, is communicatively coupled to a first UCIe x32 module 306 on a second die 308, and to a second UCIe x32 module 310 on a third die 312. As with the UCIe x64 module 104 of FIG. 1, the UCIe x64 module 302 of FIG. 3 includes a die-to-die adapter 314 and a PHY 316, with the die-to-die adapter 314 acting as a bridge between a protocol layer (not shown) of the UCIe x64 module 302 and the PHY 316. The die-to-die adapter 112 in the example of FIG. 3 is configured to interface multiple protocols such as CXL, PCIe, and streaming protocols to the PHY 316, and thus manages communications from clients 318 and 320, each of which may comprise a CXL client, a PCIe client, or a streaming client, as non-limiting examples. The die-to-die adapter 314 of FIG. 3 is further configured to provide multiple die-to-die stacks 322 and 324, each of which is used in providing x32 links to the first UCIe x32 module 306 and the second UCIe x32 module 310, respectively.

As with the PHY 114 of FIG. 1, the PHY 316 of the UCIe x64 module 302 of FIG. 3 provides an electrical interface and signaling between the first die 304 and the second and third dies 308, 312. The electrical interface includes multiple signal lanes that are grouped into electrical/AFE signal lanes 326, sideband signal lanes 328, redundant electrical/AFE signal lanes 330, and redundant sideband signal lanes 332. The electrical/AFE signal lanes 326 correspond to the mainband transmit signal lanes 202(0)-202(4) and the mainband receive signal lanes 206(0)-206(4) of FIG. 2, while the redundant electrical/AFE signal lanes 330 correspond to the redundant mainband transmit signal lanes 204(0)-204(2) and the redundant mainband receive signal lanes 208(0)-208(2) of FIG. 2. Likewise, the sideband signal lanes 328 correspond to the sideband signal lanes 210(0)-210(3) of FIG. 2, and the redundant sideband signal lanes 332 correspond to the redundant sideband signal lanes 212(0)-212(3) of FIG. 2.

In addition, the UCIe x64 module 302 provides an RDI multiplexor 334 as a layer between the die-to-die adapter 314 and the PHY 316. The RDI multiplexor 334 is responsible for routing data to and from the clients 318, 320 to the corresponding UCIe x32 modules 306, 310 respectively, when the UCIe x64 module 302 is operating in FLW mode.

In exemplary operation, the UCIe x64 module 302 determines, during a first initialization of the processor-based device 300, that the UCIe x64 module 302 supports FLW. In some aspects, the operations for determining that the UCIe x64 module 302 supports FLW may comprise the UCIe x64 module 302 determining that either one of a first FLW module configuration bit (captioned as “FLW CONFIG” in FIG. 3) 336 in a DVSEC Link Capability register (captioned as “DVSEC LINK CAP REG” in FIG. 3) 338 of the processor-based device 300 and a second FLW module configuration bit (captioned as “FLW CONFIG” in FIG. 3) 340 in a PHY control register (captioned as “PHY CONTROL REG” in FIG. 3) 342 of the processor-based device 300 is set. In some aspects, in response to determining that the UCIe x64 module 302 supports FLW, the UCIe x64 module 302 sets an FLW indication 344 of an MBINIT. PARAM message 346 that is transmitted to the first UCIe x32 module 306 and the second UCIe x32 module 310 during initialization. Upon determining that the UCIe x64 module 302 supports FLW, the UCIe x64 module 302 next determines during the first initialization of the processor-based device 300 that the UCIe x64 module 302 is communicatively coupled to the first UCIe x32 module 306 and the second UCIe x32 module 310 that require a first x32 link 348 and a second x32 link 350, respectively.

In response to determining that the UCIe x64 module 302 is communicatively coupled to the first UCIe x32 module 306 and the second UCIe x32 module 310, the UCIe x64 module 302 performs a series of operations. In some aspects, the UCIe x64 module 302 updates the DVSEC Link Capability register 338 of the processor-based device 300 to indicate a count of active modules (e.g., the UCIe x64 module 302, the first UCIe x32 module 306, and the second UCIe x32 module 310), a configuration of each active module 302, 306, 310, and a count of the die-to-die stacks 324, 322 required to support links between the UCIe x64 module 302 and the first and second UCIe x32 modules 306, 310. The UCIe x64 module 302 according to some aspects also configures the die-to-die stack 324 and the die-to-die stack 322 corresponding to the first UCIe x32 module 306 and the second UCIe x32 module 310, respectively.

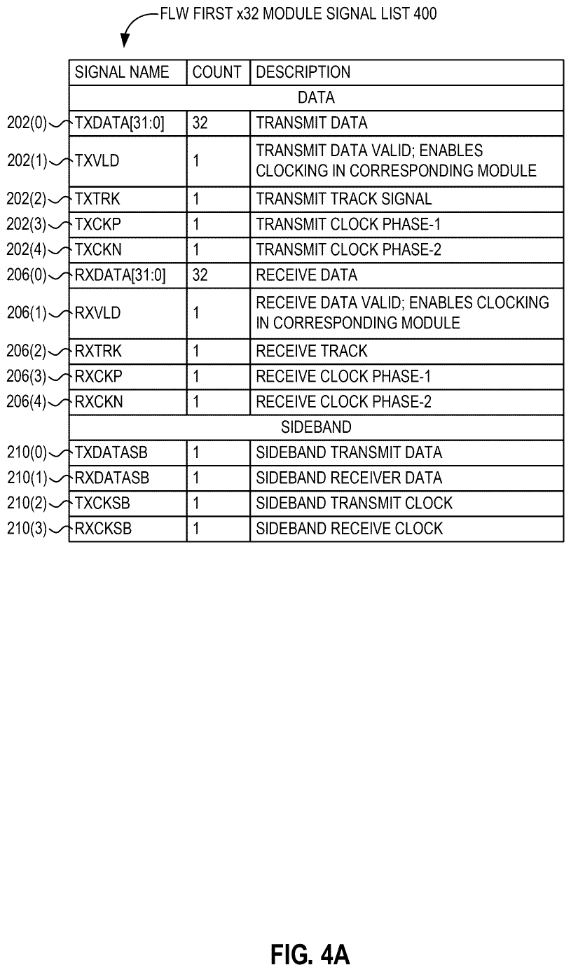

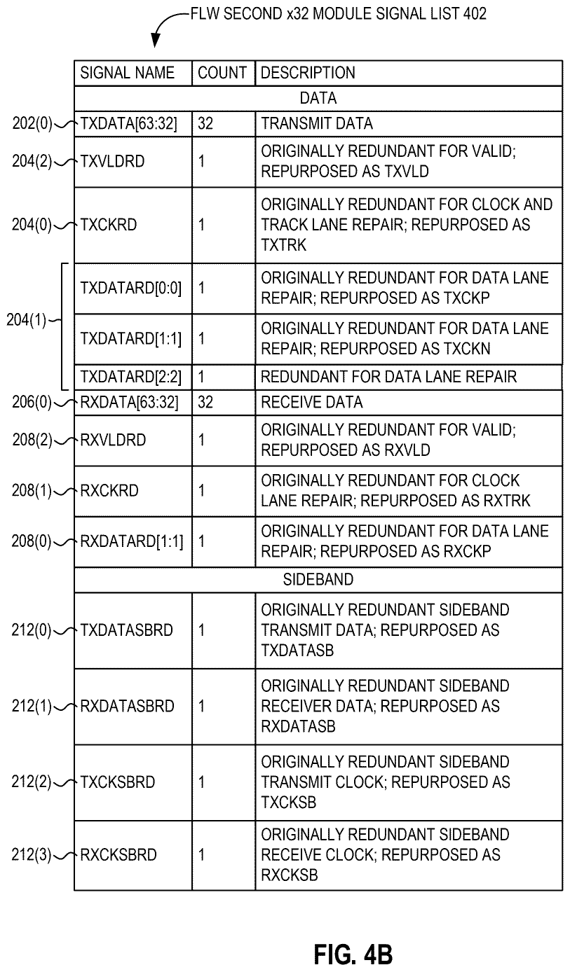

The UCIe x64 module 302 next establishes the first x32 link 348 with the first UCIe x32 module 306. As seen in FIG. 3, the first x32 link 348 includes clock signal lanes (captioned as “CLK” in FIG. 3) 352, data valid signal lanes (captioned as “VLD” in FIG. 3) 354, and 32 data signal lanes (captioned as “x32 DATA” in FIG. 3) 356 in each direction (transmit and receive) that are provided using the electrical/AFE signal lanes 326, and also includes sideband data signal lanes (captioned as “SB” in FIG. 3) 358 provided using the sideband signal lanes 328. In particular, and as discussed below in greater detail with respect to FIG. 4A, the first x32 link 348 makes use of the mainband transmit signal lanes 202(0)-202(4) including a first 32 bits of a mainband data transmit signal lane 202(0), the mainband receive signal lanes 206(0)-206(4) including a first 32 bits of a mainband data receive signal lane 206(0), and the sideband signal lanes 210(0)-210(3).

The UCIe x64 module 302 also establishes the second x32 link 350 with the second UCIe x32 module 310. The second x32 link 350 includes clock signal lanes (captioned as “CLK” in FIG. 3) 360 and data valid signal lanes (captioned as “VLD” in FIG. 3) 362 that are provided using the redundant electrical/AFE signal lanes 330, 32 data signal lanes (captioned as “x32 DATA” in FIG. 3) 364 in each direction (transmit and receive) that are provided using the electrical/AFE signal lanes 326, and sideband data signal lanes (captioned as “SB” in FIG. 3) 366 provided using the redundant sideband signal lanes 332. As discussed below in greater detail with respect to FIG. 4B, the second x32 link 350 makes use of a second 32 bits of the mainband data transmit signal lane 202(0), a second 32 bits of the mainband data receive signal lane 206(0), a plurality of redundant mainband transmit signal lanes 204(0)-204(2), a plurality of redundant mainband receive signal lanes 208(0)-208(2), and a plurality of redundant sideband signal lanes 212(0)-212(3).

The UCIe x64 module 302 then establishes data transfer via the first x32 link 348 and the second x32 link 350 by, e.g., using the RDI multiplexor 334 to arbitrate data transmitted via the first and the second x32 links 348, 350 between the first and the second die-to-die stacks 324, 322, respectively, and the PHY 316.

To illustrate how the RDI multiplexor 334 of the UCIe x64 module 302 of FIG. 3 employs the mainband transmit signal lanes 202(0)-202(4), the redundant mainband transmit signal lanes 204(0)-204(2), the mainband receive signal lanes 206(0)-206(4), the redundant mainband receive signal lanes 208(0)-208(2), the sideband signal lanes 210(0)-210(3), and the redundant sideband signal lanes 212(0)-212(3) of FIG. 2 to provide the dual x32 links 348 and 350 of FIG. 3 according to some aspects, FIGS. 4A-4B are provided. In FIG. 4A, an FLW first x32 module signal list 400 shows the signal lanes used by the RDI multiplexor 334 to provide the x32 link 348. The RDI multiplexor 334 is configured to use the lower 32 bits of the mainband data transmit signal lane 202(0) to transmit data via the x32 link 348. The RDI multiplexor 334 is further configured to use the lower 32 bits of the mainband data receive signal lane 206(0) to receive data via the x32 link 348. The remaining mainband transmit signal lanes 202(1)-202(4), the remaining mainband receive signal lanes 206(1)-206(4), and the sideband signal lanes 210(0)-210(3) are used by the RDI multiplexor 334 in the x32 link 348 in the same manner as shown in FIG. 2.

FIG. 4B provides an FLW second x32 module signal list 402 that shows how the RDI multiplexor 334 repurposes the redundant mainband transmit signal lanes 204(0)-204(2), the redundant mainband receive signal lanes 208(0)-208(2), and the redundant sideband signal lanes 212(0)-212(3) to provide the x32 link 350. As shown in FIG. 4B, the RDI multiplexor 334 is configured to use the upper 32 bits of the mainband data transmit signal lane 202(0) to transmit data via the x32 link 350. The redundant mainband data transmit signal lane 204(2) (TXVLDRD) is repurposed as the TXVLD signal lane for the x32 link 350, while the redundant mainband data transmit signal lane 204(0) (TXCKRD) is repurposed as the TXTRK signal lane for the x32 link 350. The redundant mainband data transmit signal lane 204(1) (TXDATARD) is repurposed to provide multiple signal lanes, with the lowest bit (0) serving as the TXCKP signal lane, the next higher bit (1) serving as the TXCKN signal lane, and the next higher bit (2) providing redundancy for data lane repair.

In similar fashion, the RDI multiplexor 334 further uses the upper 32 bits of the mainband data receive signal lane 206(0) to receive data via the x32 link 350. The redundant mainband data receive signal lane 208(2) (RXVLDRD) is repurposed as the RXVLD signal lane for the x32 link 350, and the redundant mainband data receive signal lane 208(1) (RXCKRD) is repurposed as the RXTRK signal lane for the x32 link 350. The lowest bit of the redundant mainband data receive signal lane 208(0) (RXDATARD) is also repurposed to provide the RXCKP signal lane for the x32 link 350. The RDI multiplexor 334 also repurposes the redundant sideband signal lanes 212(0)-212(3) (TXDATASBRD, RXDATASBRD, TXCKSBRD, and RXCKSBRD, respectively) to provide the TXDATASB, RXDATASB, TXCKSB, and RXCKSB sideband signal lanes, respectively, for the x32 link 350.

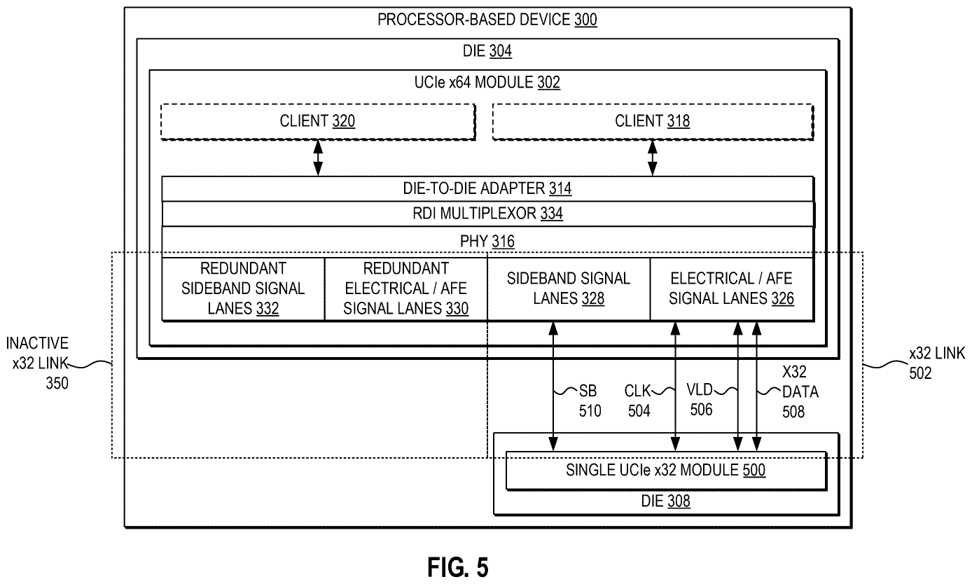

FIG. 5 illustrates a further exemplary aspect of the UCIe x64 module 302 of FIG. 3 in which the UCIe x64 module 302 is communicatively coupled to a single UCIe x32 module 500 that requires a third x32 link 502. In exemplary operation, in determining that the UCIe x64 module 302 is communicatively coupled to the single UCIe x32 module 500, the UCIe x64 module 302 establishes the third x32 link 502 with the single UCIe x32 module 500 using the plurality of mainband transmit signal lanes 202(0)-202(4) including the first 32 bits of the mainband data transmit signal lane 202(0), the plurality of mainband receive signal lanes 206(0)-206(4) including the first 32 bits of the mainband data receive signal lane 206(0), and the plurality of sideband signal lanes 210(0)-210(3). As seen in FIG. 5, the third x32 link 502 includes clock signal lanes (captioned as “CLK” in FIG. 5) 504, data valid signal lanes (captioned as “VLD” in FIG. 5) 506, 32 data signal lanes (captioned as “x32 DATA” in FIG. 5) 508 in each direction (transmit and receive) that are provided using the electrical/AFE signal lanes 326, and sideband data signal lanes (captioned as “SB” in FIG. 5) 510 provided using the sideband signal lanes 328. The UCIe x64 module 302 then establishes data transfer via the third x32 link 502.

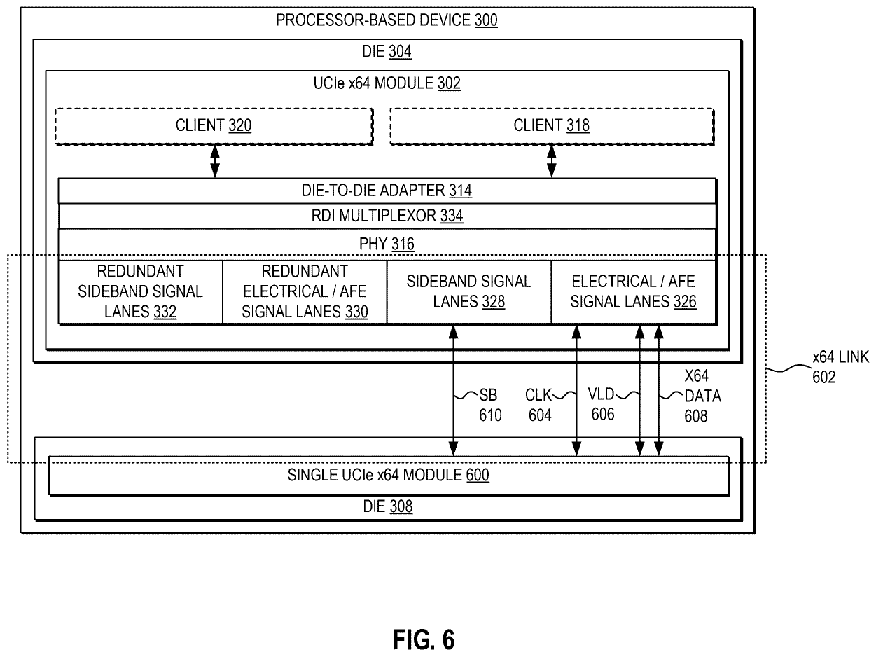

Similarly, FIG. 6 illustrates another exemplary aspect of the UCIe x64 module 302 in which the UCIe x64 module 302 is communicatively coupled to a single UCIe x64 module 600 that requires an x64 link 602. Upon determining that the UCIe x64 module 302 is communicatively coupled to the single UCIe x64 module 600, the UCIe x64 module 302 in such aspects establishes the x64 link 602 with the single UCIe x64 module 600 using the plurality of mainband transmit signal lanes 202(0)-202(4) including all 64 bits of the mainband data transmit signal lane 202(0), the plurality of mainband receive signal lanes 206(0)-206(4) including all 64 bits of the mainband data receive signal lane 206(0), and the plurality of sideband signal lanes 210(0)-210(3). As shown in FIG. 6, the x64 link 602 includes clock signal lanes (captioned as “CLK” in FIG. 6) 604, data valid signal lanes (captioned as “VLD” in FIG. 6) 606, and 64 data signal lanes (captioned as “x64 DATA” in FIG. 6) 608 in each direction (transmit and receive) that are provided using the electrical/AFE signal lanes 326, and also includes sideband data signal lanes (captioned as “SB” in FIG. 6) 610 provided using the sideband signal lanes 328. The UCIe x64 module 302 then establishes data transfer via the x64 link 602.

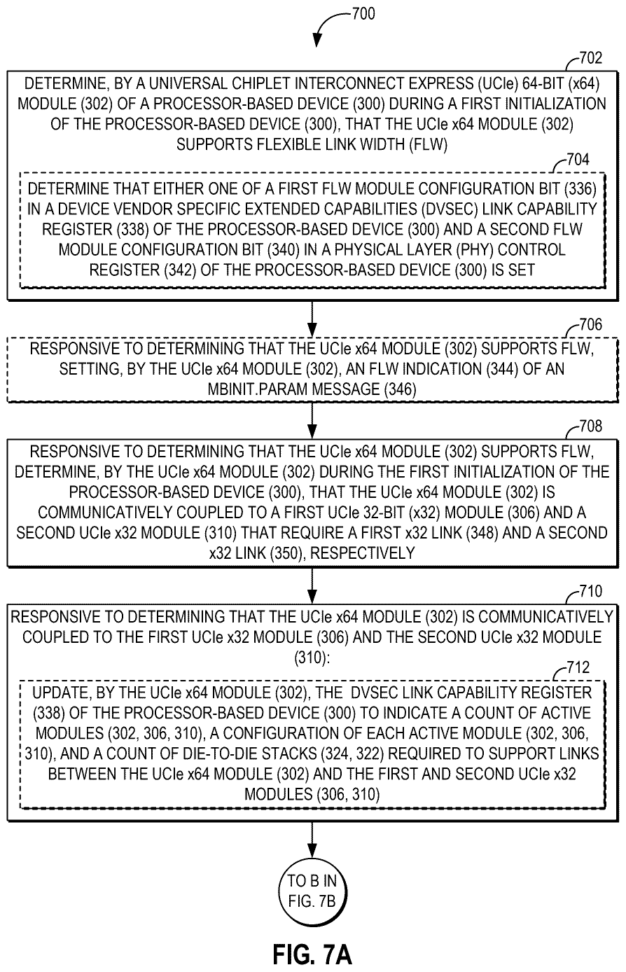

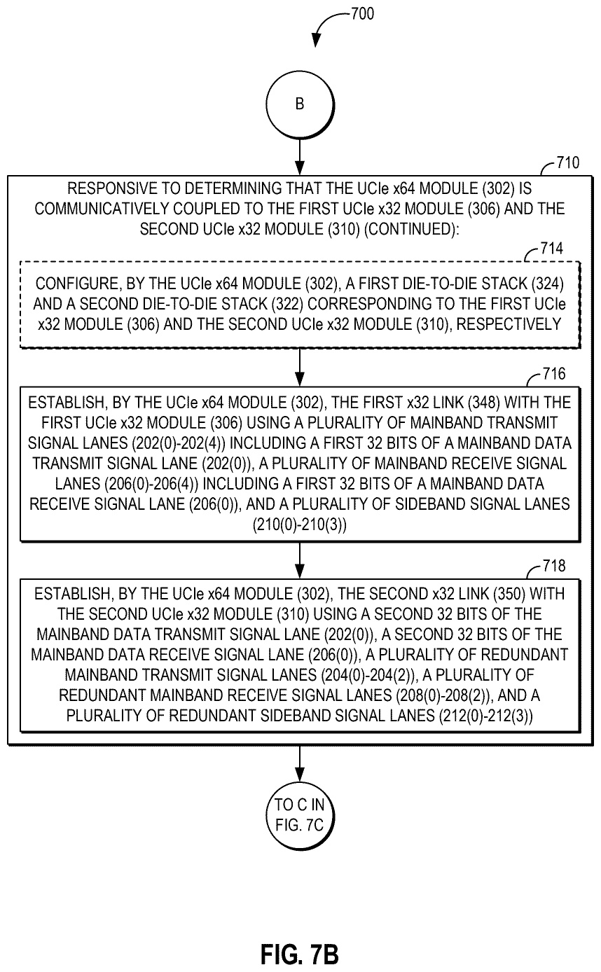

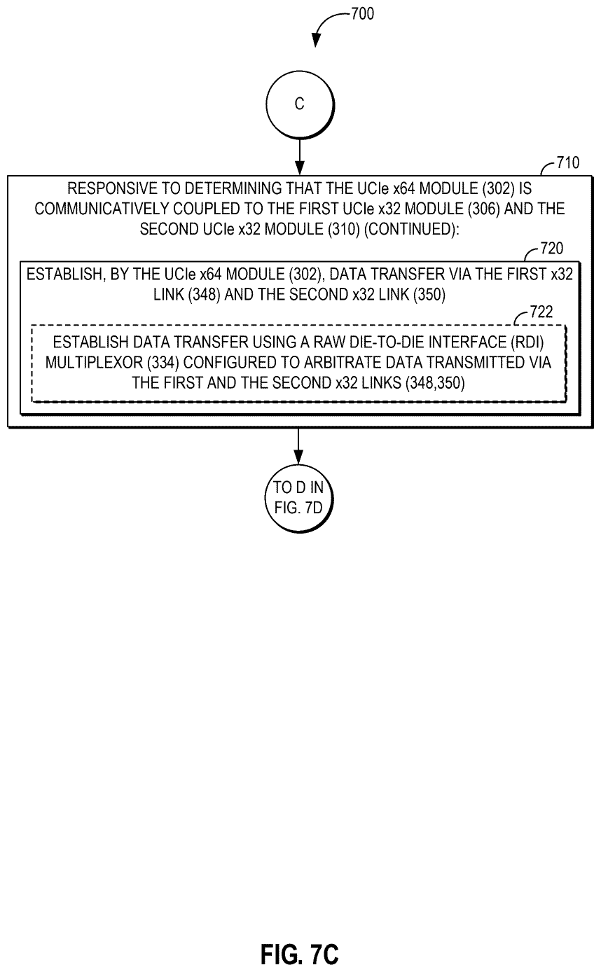

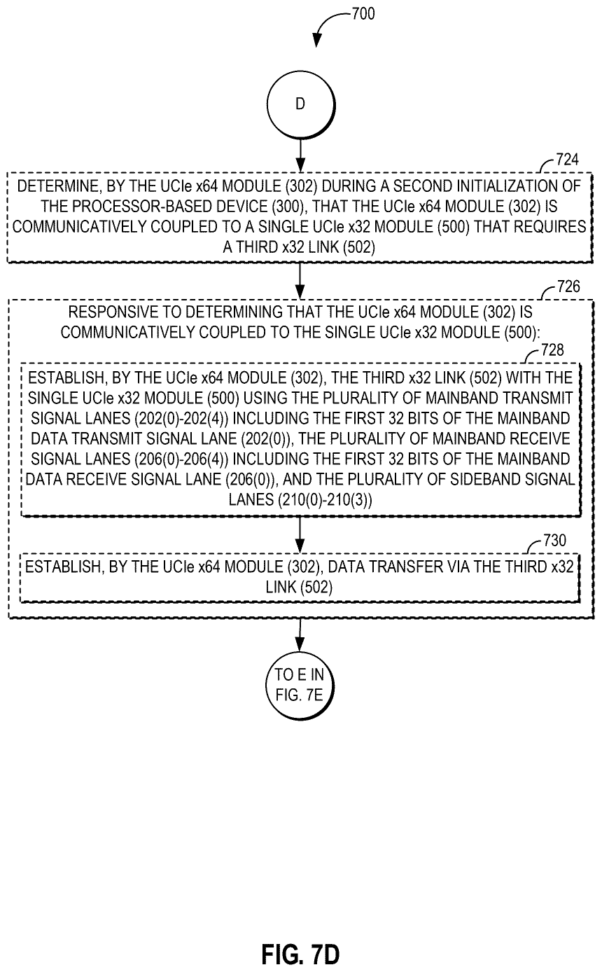

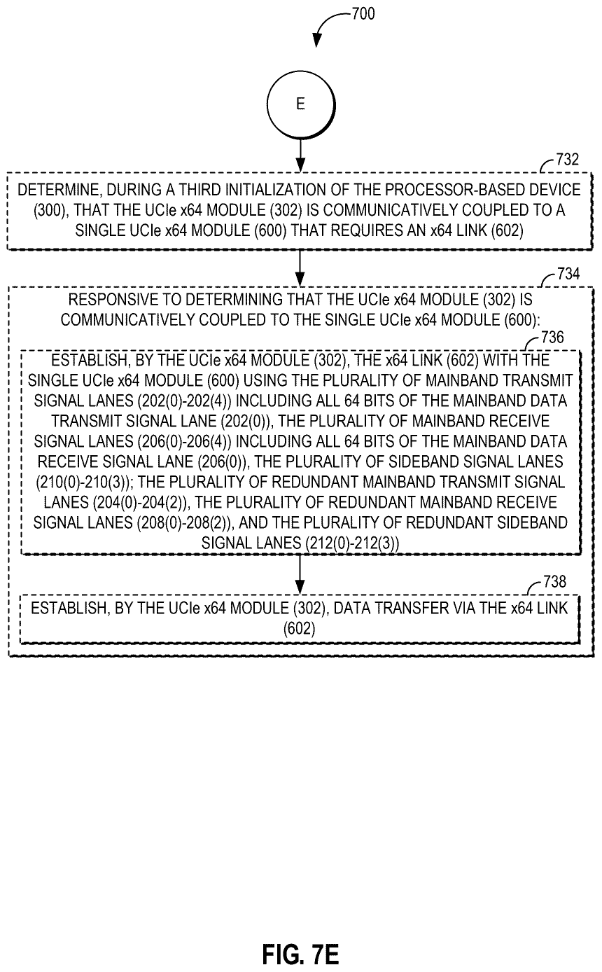

To illustrate operations performed by the UCIe x64 module 302 of FIGS. 3-6 for providing FLW dual x32 links according to some aspects, FIGS. 7A-7E provide a flowchart showing exemplary operations 700. For the sake of clarity, elements of FIGS. 2-6 are referenced in describing FIGS. 7A-7E. It is to be understood that some aspects may provide that some operations illustrated in Figure FIGS. 7A-7E may be performed in an order other than that illustrated herein, and/or may be omitted.

The exemplary operations 700 begin in FIG. 7A with a UCIe x64 module (e.g., the UCIe x64 module 302 of FIG. 3) of a processor-based device (such as the processor-based device 300 of FIG. 3) determining, during a first initialization of the processor-based device 300, that the UCIe x64 module 302 supports FLW (block 702). In some aspects, the operations of block 702 for determining that the UCIe x64 module 302 supports FLW may comprise the UCIe x64 module 302 determining that either one of a first FLW module configuration bit (e.g., the FLW module configuration bit 336 of FIG. 3) in a DVSEC Link Capability register (such as the DVSEC Link Capability register 338 of FIG. 3) of the processor-based device 300 and a second FLW module configuration bit (e.g., the FLW module configuration bit 340 of FIG. 3) in a PHY control register (such as the PHY control register 342 of FIG. 3) of the processor-based device 300 is set (block 704). In some aspects, in response to determining that the UCIe x64 module 302 supports FLW, the UCIe x64 module 302 sets an FLW indication (e.g., the FLW indication 344 of FIG. 3) of an MBINIT.PARAM message (such as the MBINIT.PARAM message of FIG. 3) 346 (block 706).

Responsive to determining that the UCIe x64 module 302 supports FLW, the UCIe x64 module 302 determines during the first initialization of the processor-based device 300 that the UCIe x64 module 302 is communicatively coupled to a first UCIe x32 module (e.g., the UCIe x32 module 306 of FIG. 3) and a second UCIe x32 module (such as the UCIe x32 module 310 of FIG. 3) that require a first x32 link (e.g., the x32 link 348 of FIG. 3) and a second x32 link (such as the x32 link 350 of FIG. 3), respectively (block 708). In response to determining that the UCIe x64 module 302 is communicatively coupled to the first UCIe x32 module 306 and the second UCIe x32 module 310, the UCIe x64 module 302 performs a series of operations (block 710). In some aspects, the UCIe x64 module 302 updates the DVSEC Link Capability register 338 of the processor-based device 300 to indicate a count of active modules (e.g., the UCIe x64 module 302, the first UCIe x32 module 306, and the second UCIe x32 module 310 of FIG. 3), a configuration of each active module 302, 306, 310, and a count of die-to-die stacks (such as the die-to-die stacks 324, 322 of FIG. 3) required to support links between the UCIe x64 module 302 and the first and second UCIe x32 modules 306, 310 (block 712). The exemplary operations 700 in some aspects may continue at block 714 of FIG. 7B.

Turning now to FIG. 7B, the operations performed by the UCIe x64 module 302 in response to determining that the UCIe x64 module 302 is communicatively coupled to the first UCIe x32 module 306 and the second UCIe x32 module 310 continue (block 710). According to some aspects, the UCIe x64 module 302 configures a first die-to-die stack (e.g., the die-to-die stack 324 of FIG. 3) and a second die-to-die stack (such as the die-to-die stack 322 of FIG. 3) corresponding to the first UCIe x32 module 306 and the second UCIe x32 module 310, respectively (block 714).

The UCIe x64 module 302 next establishes the first x32 link 348 with the first UCIe x32 module 306 using a plurality of mainband transmit signal lanes (e.g., the mainband transmit signal lanes 202(0)-202(4) of FIG. 2) including a first 32 bits of a mainband data transmit signal lane (such as the mainband data transmit signal lane 202(0) of FIG. 2), a plurality of mainband receive signal lanes (e.g., the mainband receive signal lanes 206(0)-206(4) of FIG. 2) including a first 32 bits of a mainband data receive signal lane (such as the mainband data receive signal lane 206(0) of FIG. 2), and a plurality of sideband signal lanes (e.g., the sideband signal lanes 210(0)-210(3) of FIG. 2) (block 716). The UCIe x64 module 302 also establishes the second x32 link 350 with the second UCIe x32 module 310 using a second 32 bits of the mainband data transmit signal lane 202(0), a second 32 bits of the mainband data receive signal lane 206(0), a plurality of redundant mainband transmit signal lanes (e.g., the redundant mainband transmit signal lanes 204(0)-204(2) of FIG. 2), a plurality of redundant mainband receive signal lanes (such as the redundant mainband receive signal lanes 208(0)-208(2) of FIG. 2), and a plurality of redundant sideband signal lanes (e.g., the redundant sideband signal lanes 212(0)-212(3) of FIG. 2) (block 718). The exemplary operations 700 continue at block 720 of FIG. 7C.

Referring now to 7C, the operations performed by the UCIe x64 module 302 in response to determining that the UCIe x64 module 302 is communicatively coupled to the first UCIe x32 module 306 and the second UCIe x32 module 310 continue (block 710). The UCIe x64 module 302 establishes data transfer via the first x32 link 348 and the second x32 link 350 (block 720). Some aspects may provide that the operations of block 720 for establishing data transfer via the first x32 link 348 and the second x32 link 350 may comprise establishing data transfer using an RDI multiplexor (such as the RDI multiplexor 334 of FIG. 3) configured to arbitrate data transmitted via the first and the second x32 links 348, 350 (e.g., between the first and the second die-to-die stacks 324, 322, respectively, and the PHY 316 of FIG. 3) (block 722). The exemplary operations 700 according to some aspects may continue at block 724 of FIG. 7D.

With reference now to FIG. 7D, in some aspects, the UCIe x64 module 302 may determine during a second initialization of the processor-based device 300 that the UCIe x64 module 302 is communicatively coupled to a single UCIe x32 module (such as the single UCIe x32 module 500 of FIG. 5) that requires a third x32 link (e.g., the x32 link 502 of FIG. 5) (block 724). Responsive to determining that the UCIe x64 module 302 is communicatively coupled to the single UCIe x32 module 500, the UCIe x64 module 302 in such aspects performs a series of operations (block 726). The UCIe x64 module 302 establishes the third x32 link 502 with the single UCIe x32 module 500 using the plurality of mainband transmit signal lanes 202(0)-202(4) including the first 32 bits of the mainband data transmit signal lane 202(0), the plurality of mainband receive signal lanes 206(0)-206(4) including the first 32 bits of the mainband data receive signal lane 206(0), and the plurality of sideband signal lanes 210(0)-210(3) (block 728). The UCIe x64 module 302 then establishes data transfer via the third x32 link 502 (block 730). The exemplary operations 700 in some aspects may continue at block 732 of FIG. 7E.

Turning now to FIG. 7E, the UCIe x64 module 302 according to some aspects may determine during a third initialization of the processor-based device 300 that the UCIe x64 module 302 is communicatively coupled to a single UCIe x64 module (such as the single UCIe x64 module 600 of FIG. 6) that requires an x64 link (e.g., the x64 link 602 of FIG. 6) (block 732). In response to determining that the UCIe x64 module 302 is communicatively coupled to the single UCIe x64 module 600, the UCIe x64 module 302 in such aspects performs a series of operations (block 734). The UCIe x64 module 302 establishes the x64 link 602 with the single UCIe x64 module 600 using the plurality of mainband transmit signal lanes 202(0)-202(4) including all 64 bits of the mainband data transmit signal lane 202(0), the plurality of mainband receive signal lanes 206(0)-206(4) including all 64 bits of the mainband data receive signal lane 206(0), the plurality of sideband signal lanes 210(0)-210(3), the plurality of redundant mainband transmit signal lanes 204(0)-204(2), the plurality of redundant mainband receive signal lanes 208(0)-208(2), and the plurality of redundant sideband signal lanes 212(0)-212(3) (block 736). The UCIe x64 module 302 then establishes data transfer via the x64 link 602 (block 738).

The processor-based device according to aspects disclosed herein and discussed with reference to FIGS. 1-3, 5, and 6 may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

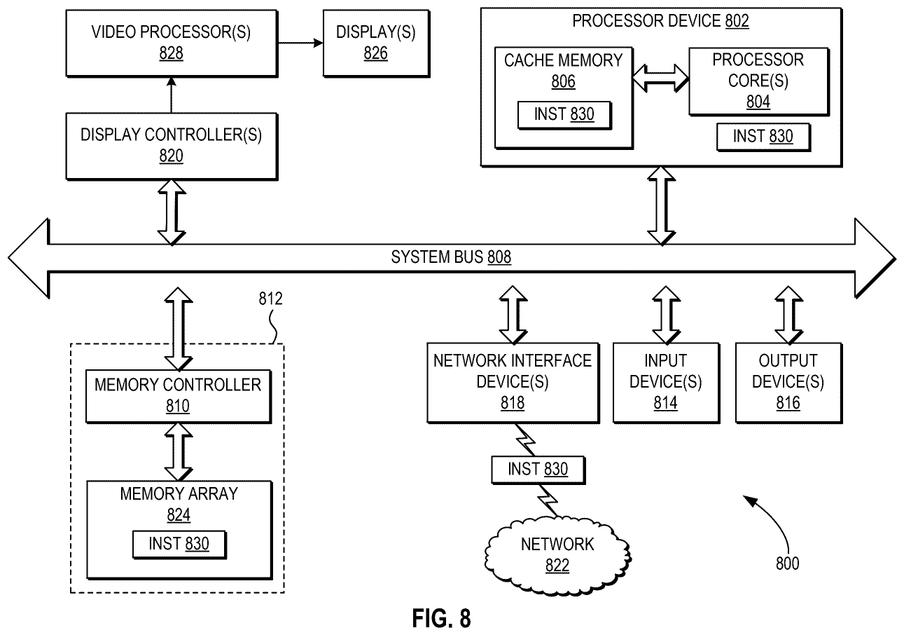

In this regard, FIG. 8 illustrates an example of a processor-based device 800, which corresponds in functionality to the processor-based device 300 of FIG. 3. In this example, the processor-based device 800 includes a processor device 802 that comprises one or more processor cores 804 coupled to a cache memory 806. The processor device 802 is also coupled to a system bus 808 and can intercouple devices included in the processor-based device 800. As is well known, the processor device 802 communicates with these other devices by exchanging address, control, and data information over the system bus 808. For example, the processor device 802 can communicate bus transaction requests to a memory controller 810. Although not illustrated in FIG. 8, multiple system buses 808 could be provided, wherein each system bus 808 constitutes a different fabric.

Other devices may be connected to the system bus 808. As illustrated in FIG. 8, these devices can include a memory system 812, one or more input devices 814, one or more output devices 816, one or more network interface devices 818, and one or more display controllers 820, as examples. The input device(s) 814 can include any type of input device, including, but not limited to, input keys, switches, voice processors, etc. The output device(s) 816 can include any type of output device, including, but not limited to, audio, video, other visual indicators, etc. The network interface device(s) 818 can be any devices configured to allow exchange of data to and from a network 822. The network 822 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 818 can be configured to support any type of communications protocol desired. The memory system 812 can include the memory controller 810 coupled to one or more memory arrays 824.

The processor device 802 may also be configured to access the display controller(s) 820 over the system bus 808 to control information sent to one or more displays 826. The display controller(s) 820 sends information to the display(s) 826 to be displayed via one or more video processors 828, which process the information to be displayed into a format suitable for the display(s) 826. The display(s) 826 can include any type of display, including, but not limited to, a cathode ray tube (CRT), a liquid crystal display (LCD), a plasma display, a light emitting diode (LED) display, etc.

The processor-based device 800 in FIG. 8 may include a set of instructions (captioned as “INST” in FIG. 8) 830 that may be executed by the processor device 802 for any application desired according to the instructions. The instructions 830 may be stored in the memory system 812, the processor device 802, and/or the cache memory 806, each of which may comprise an example of a non-transitory computer-readable medium. The instructions 830 may also reside, completely or at least partially, within the memory system 812 and/or within the processor device 802 during their execution. The instructions 830 may further be transmitted or received over the network 822, such that the network 822 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the set of instructions 830. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

It is to be understood that the terms “top,” “upper,” “above,” and “bottom,” “lower,” “below,” where used herein, are relative terms and are not meant to limit or imply a strict orientation. A “top” or “upper” or “above” referenced element does not always need to be oriented to be above a “bottom,” or “lower,” or “below” referenced element with respect to ground, and vice versa. An element referenced as “top,” “upper,” “above,” or “bottom,” “lower,” “below,” may be on top or bottom relative to that example only and the particular illustrated example. An element referenced as “top” or “upper” or “above” “bottom,” “lower,” “below,” another element does not have to be with respect to ground, and vice versa. An element referenced as “top” or “upper” or “above” may be above or below such other referenced element, relative to that example only and the particular illustrated example. For example, if a particular object that is discussed as at “top,” or “upper” or “above” another object, and such particular object is flipped 180 degrees, then such particular object would then be oriented as at “bottom,” or “lower” or “below” such other object.

Further, an object being “adjacent” as discussed herein relates to an object being beside or next to another stated object. Adjacent objects may not be directly physically coupled to each other. An object can be directly adjacent to another object which means that such objects are directly beside or next to the other object without another object or layer being intervening or disposed between the directly adjacent objects. An object can be indirectly or non-directly adjacent to another object which means that such objects are not directly beside or directly next to each other, but there is an intervening object or layer disposed between the non-directly adjacent objects.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor-based device, comprising:
a Universal Chiplet Interconnect Express (UCIe) 64-bit (x64 ) module configured to:
   determine, during a first initialization of the processor-based device, that the UCIe x64 module supports Flexible Link Width (FLW);
   responsive to determining that the UCIe x64 module supports FLW, determine, during the first initialization of the processor-based device, that the UCIe x64 module is communicatively coupled to a first UCIe 32-bit (x32) module and a second UCIe x32 module that require a first x32 link and a second x32 link, respectively; and
   responsive to determining that the UCIe x64 module is communicatively coupled to the first UCIe x32 module and the second UCIe x32 module:
      establish the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes;
      establish the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes; and
      establish data transfer via the first x32 link and the second x32 link.
         2. The processor-based device of clause 1, wherein the UCIe x64 module is configured to determine that the UCIe x64 module supports FLW by being configured to determine that either one of a first FLW module configuration bit in a Device Vendor Specific Extended Capabilities (DVSEC) Link Capability register of the processor-based device and a second FLW module configuration bit in a physical layer (PHY) control register of the processor-based device is set.
         3. The processor-based device of clause 2, wherein the UCIe x64 module is further configured to, responsive to determining that the UCIe x64 module supports FLW, set an FLW indication of an MBINIT. PARAM message.
         4. The processor-based device of any one of clauses 1-3, wherein the UCIe x64 module is further configured to, subsequent to determining that the first UCIe x32 module and the second UCIe x32 module require the first x32 link and the second x32 link, respectively:
update a Device Vendor Specific Extended Capabilities (DVSEC) Link Capability register of the processor-based device to indicate a count of active modules, a configuration of each active module, and a count of die-to-die stacks required to support links between the UCIe x64 module and the first and second UCIe x32 modules; and
configure a first die-to-die stack and a second die-to-die stack corresponding to the first UCIe x32 module and the second UCIe x32 module, respectively.
   5. The processor-based device of clause 4, wherein:
the UCIe x64 module comprises a Raw Die-to-Die Interface (RDI) multiplexor configured to arbitrate data transmitted via the first and the second x32 links; and
the UCIe x64 module is configured to establish the data transfer via the first x32 link and the second x32 link using the RDI multiplexor.
   6. The processor-based device of any one of clauses 1-5, wherein the UCIe x64 module is further configured to:
determine, during a second initialization of the processor-based device, that the UCIe x64 module is communicatively coupled to a single UCIe x32 module that requires a third x32 link; and
responsive to determining that the UCIe x64 module is communicatively coupled to the single UCIe x32 module:
   establish the third x32 link with the single UCIe x32 module using the plurality of mainband transmit signal lanes including the first 32 bits of the mainband data transmit signal lane, the plurality of mainband receive signal lanes including the first 32 bits of the mainband data receive signal lane, and the plurality of sideband signal lanes; and
   establish data transfer via the third x32 link.
      7. The processor-based device of any one of clauses 1-6, wherein the UCIe x64 module is further configured to:
determine, during a third initialization of the processor-based device, that the UCIe x64 module is communicatively coupled to a single UCIe x64 module that requires an x64 link; and
responsive to determining that the UCIe x64 module is communicatively coupled to the single UCIe x64 module:
   establish the x64 link with the single UCIe x64 module using the plurality of mainband transmit signal lanes including all 64 bits of the mainband data transmit signal lane, the plurality of mainband receive signal lanes including all 64 bits of the mainband data receive signal lane, the plurality of sideband signal lanes, the plurality of redundant mainband transmit signal lanes, the plurality of redundant mainband receive signal lanes, and the plurality of redundant sideband signal lanes; and
   establish data transfer via the x64 link.
      8. The processor-based device of any one of clauses 1-7, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
      9. A processor-based device, comprising:
means for determining, during a first initialization of the processor-based device, that a Universal Chiplet Interconnect Express (UCIe) 64-bit (x64) module of the processor-based device supports Flexible Link Width (FLW);
means for determining, during the first initialization of the processor-based device, that the UCIe x64 module is communicatively coupled to a first UCIe 32-bit (x32) module and a second UCIe x32 module that require a first x32 link and a second x32 link, respectively, responsive to determining that the UCIe x64 module supports FLW;
means for establishing the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes, responsive to determining that the UCIe x64 module is communicatively coupled to the first UCIe x32 module and the second UCIe x32 module;
means for establishing the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes, responsive to determining that the UCIe x64 module is communicatively coupled to the first UCIe x32 module and the second UCIe x32 module; and
means for establishing data transfer via the first x32 link and the second x32 link, responsive to determining that the UCIe x64 module is communicatively coupled to the first UCIe x32 module and the second UCIe x32 module.
   10. A method for providing Flexible Link Width (FLW) dual 32-bit (x32) links in Universal Chiplet Interconnect Express (UCIe) 64-bit (x64) modules, comprising:
determining, by a UCIe x64 module during a first initialization of a processor-based device, that the UCIe x64 module supports FLW;
responsive to determining that the UCIe x64 module supports FLW, determining, by the UCIe x64 module during the first initialization of the processor-based device, that the UCIe x64 module is communicatively coupled to a first UCIe x32 module and a second UCIe x32 module that require a first x32 link and a second x32 link, respectively; and
responsive to determining that the UCIe x64 module is communicatively coupled to the first UCIe x32 module and the second UCIe x32 module:
   establishing, by the UCIe x64 module, the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes;
   establishing, by the UCIe x64 module, the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes; and
   establishing, by the UCIe x64 module, data transfer via the first x32 link and the second x32 link.
      11. The method of clause 10, wherein determining that the UCIe x64 module supports FLW comprises determining that either one of a first FLW module configuration bit in a Device Vendor Specific Extended Capabilities (DVSEC) Link Capability register of the processor-based device and a second FLW module configuration bit in a physical layer (PHY) control register of the processor-based device is set.
      12. The method of clause 11, further comprising, responsive to determining that the UCIe x64 module supports FLW, setting, by the UCIe x64 module, an FLW indication of an MBINIT. PARAM message.
      13. The method of any one of clauses 10-12, further comprising, subsequent to determining that the first UCIe x32 module and the second UCIe x32 module require the first x32 link and the second x32 link, respectively:
updating, by the UCIe x64 module, a Device Vendor Specific Extended Capabilities (DVSEC) Link Capability register of the processor-based device to indicate a count of active modules, a configuration of each active module, and a count of die-to-die stacks required to support links between the UCIe x64 module and the first and second UCIe x32 modules; and
configuring, by the UCIe x64 module, a first die-to-die stack and a second die-to-die stack corresponding to the first UCIe x32 module and the second UCIe x32 module, respectively.
   14. The method of clause 13, wherein:
the UCIe x64 module comprises a Raw Die-to-Die Interface (RDI) multiplexor configured to arbitrate data transmitted via the first and the second x32 links; and
establishing the data transfer via the first x32 link and the second x32 link comprises establishing data transfer using the RDI multiplexor.
   15. The method of any one of clauses 10-14, further comprising:
determining, by the UCIe x64 module during a second initialization of the processor-based device, that the UCIe x64 module is communicatively coupled to a single UCIe x32 module that requires a third x32 link; and
responsive to determining that the UCIe x64 module is communicatively coupled to the single UCIe x32 module:
   establishing, by the UCIe x64 module, the third x32 link with the single UCIe x32 module using the plurality of mainband transmit signal lanes including the first 32 bits of the mainband data transmit signal lane, the plurality of mainband receive signal lanes including the first 32 bits of the mainband data receive signal lane, and the plurality of sideband signal lanes; and
   establishing, by the UCIe x64 module, data transfer via the third x32 link.
      16. The method of any one of clauses 10-15, further comprising:
determining, during a third initialization of the processor-based device, that the UCIe x64 module is communicatively coupled to a single UCIe x64 module that requires an x64 link; and
responsive to determining that the UCIe x64 module is communicatively coupled to the single UCIe x64 module:
   establishing, by the UCIe x64 module, the x64 link with the single UCIe x64 module using the plurality of mainband transmit signal lanes including all 64 bits of the mainband data transmit signal lane, the plurality of mainband receive signal lanes including all 64 bits of the mainband data receive signal lane, the plurality of sideband signal lanes, the plurality of redundant mainband transmit signal lanes, the plurality of redundant mainband receive signal lanes, and the plurality of redundant sideband signal lanes; and
   establishing, by the UCIe x64 module, data transfer via the x64 link.
      17. A non-transitory computer-readable medium, having stored thereon computer-executable instructions that, when executed by a processor device of a processor-based device, cause a Universal Chiplet Interconnect Express (UCIe) 64-bit (x64) module of the processor device to:
determine, during a first initialization of the processor-based device, that the UCIe x64 module supports Flexible Link Width (FLW);
responsive to determining that the UCIe x64 module supports FLW, determine, during the first initialization of the processor-based device, that the UCIe x64 module is communicatively coupled to a first UCIe 32-bit (x32) module and a second UCIe x32 module that require a first x32 link and a second x32 link, respectively; and
responsive to determining that the UCIe x64 module is communicatively coupled to the first UCIe x32 module and the second UCIe x32 module:
   establish the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes;
   establish the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes; and
   establish data transfer via the first x32 link and the second x32 link.
      18. The non-transitory computer-readable medium of clause 17, wherein the computer-executable instructions cause the UCIe x64 module to determine that the UCIe x64 module supports FLW by causing the UCIe x64 module to determine that either one of a first FLW module configuration bit in a Device Vendor Specific Extended Capabilities (DVSEC) Link Capability register of the processor-based device and a second FLW module configuration bit in a physical layer (PHY) control register of the processor-based device is set.
      19. The non-transitory computer-readable medium of clause 18, wherein the computer-executable instructions further cause the UCIe x64 module to, responsive to determining that the UCIe x64 module supports FLW, set an FLW indication of an MBINIT. PARAM message.
      20. The non-transitory computer-readable medium of any one of clauses 17-19, wherein the computer-executable instructions further cause the UCIe x64 module to, subsequent to determining that the first UCIe x32 module and the second UCIe x32 module require the first x32 link and the second x32 link, respectively:
update a Device Vendor Specific Extended Capabilities (DVSEC) Link Capability register of the processor-based device to indicate a count of active modules, a configuration of each active module, and a count of die-to-die stacks required to support links between the UCIe x64 module and the first and second UCIe x32 modules; and

configure a first die-to-die stack and a second die-to-die stack corresponding to the first UCIe x32 module and the second UCIe x32 module, respectively.

What is claimed is:

1. A processor-based device, comprising:
a Universal Chiplet Interconnect Express (UCIe) 64-bit (x64) module configured to:
determine, during a first initialization of the processor-based device, that the UCIe x64 module supports Flexible Link Width (FLW);
responsive to determining that the UCIe x64 module supports FLW, determine, during the first initialization of the processor-based device, that the UCIe x64 module is communicatively coupled to a first UCIe 32-bit (x32) module and a second UCIe x32 module that require a first x32 link and a second x32 link, respectively; and
responsive to determining that the UCIe x64 module is communicatively coupled to the first UCIe x32 module and the second UCIe x32 module:
establish the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes;
establish the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes; and
establish data transfer via the first x32 link and the second x32 link.

2. The processor-based device of claim 1, wherein the UCIe x64 module is configured to determine that the UCIe x64 module supports FLW by being configured to determine that either one of a first FLW module configuration bit in a Device Vendor Specific Extended Capabilities (DVSEC) Link Capability register of the processor-based device and a second FLW module configuration bit in a physical layer (PHY) control register of the processor-based device is set.

3. The processor-based device of claim 2, wherein the UCIe x64 module is further configured to, responsive to determining that the UCIe x64 module supports FLW, set an FLW indication of an MBINIT.PARAM message.

4. The processor-based device of claim 1, wherein the UCIe x64 module is further configured to, subsequent to determining that the first UCIe x32 module and the second UCIe x32 module require the first x32 link and the second x32 link, respectively:
update a Device Vendor Specific Extended Capabilities (DVSEC) Link Capability register of the processor-based device to indicate a count of active modules, a configuration of each active module, and a count of die-to-die stacks required to support links between the UCIe x64 module and the first and second UCIe x32 modules; and
configure a first die-to-die stack and a second die-to-die stack corresponding to the first UCIe x32 module and the second UCIe x32 module, respectively.

5. The processor-based device of claim 4, wherein:
the UCIe x64 module comprises a Raw Die-to-Die Interface (RDI) multiplexor configured to arbitrate data transmitted via the first and the second x32 links; and
the UCIe x64 module is configured to establish the data transfer via the first x32 link and the second x32 link using the RDI multiplexor.

6. The processor-based device of claim 1, wherein the UCIe x64 module is further configured to:
determine, during a second initialization of the processor-based device, that the UCIe x64 module is communicatively coupled to a single UCIe x32 module that requires a third x32 link; and
responsive to determining that the UCIe x64 module is communicatively coupled to the single UCIe x32 module:
establish the third x32 link with the single UCIe x32 module using the plurality of mainband transmit signal lanes including the first 32 bits of the mainband data transmit signal lane, the plurality of mainband receive signal lanes including the first 32 bits of the mainband data receive signal lane, and the plurality of sideband signal lanes; and
establish data transfer via the third x32 link.

7. The processor-based device of claim 1, wherein the UCIe x64 module is further configured to:
determine, during a third initialization of the processor-based device, that the UCIe x64 module is communicatively coupled to a single UCIe x64 module that requires an x64 link; and
responsive to determining that the UCIe x64 module is communicatively coupled to the single UCIe x64 module:
establish the x64 link with the single UCIe x64 module using the plurality of mainband transmit signal lanes including all 64 bits of the mainband data transmit signal lane, the plurality of mainband receive signal lanes including all 64 bits of the mainband data receive signal lane, the plurality of sideband signal lanes, the plurality of redundant mainband transmit signal lanes, the plurality of redundant mainband receive signal lanes, and the plurality of redundant sideband signal lanes; and
establish data transfer via the x64 link.

8. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A processor-based device, comprising:
means for determining, during a first initialization of the processor-based device, that a Universal Chiplet Interconnect Express (UCIe) 64-bit (x64) module of the processor-based device supports Flexible Link Width (FLW);
means for determining, during the first initialization of the processor-based device, that the UCIe x64 module is communicatively coupled to a first UCIe 32-bit (x32) module and a second UCIe x32 module that require a first x32 link and a second x32 link, respectively, responsive to determining that the UCIe x64 module supports FLW;
means for establishing the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes, responsive to determining that the UCIe x64 module is communicatively coupled to the first UCIe x32 module and the second UCIe x32 module;
means for establishing the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes, responsive to determining that the UCIe x64 module is communicatively coupled to the first UCIe x32 module and the second UCIe x32 module; and
means for establishing data transfer via the first x32 link and the second x32 link, responsive to determining that the UCIe x64 module is communicatively coupled to the first UCIe x32 module and the second UCIe x32 module.

10. A method for providing Flexible Link Width (FLW) dual 32-bit (x32) links in Universal Chiplet Interconnect Express (UCIe) 64-bit (x64) modules, comprising:
determining, by a UCIe x64 module during a first initialization of a processor-based device, that the UCIe x64 module supports FLW;
responsive to determining that the UCIe x64 module supports FLW, determining, by the UCIe x64 module during the first initialization of the processor-based device, that the UCIe x64 module is communicatively coupled to a first UCIe x32 module and a second UCIe x32 module that require a first x32 link and a second x32 link, respectively; and
responsive to determining that the UCIe x64 module is communicatively coupled to the first UCIe x32 module and the second UCIe x32 module:
establishing, by the UCIe x64 module, the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes;
establishing, by the UCIe x64 module, the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes; and
establishing, by the UCIe x64 module, data transfer via the first x32 link and the second x32 link.

11. The method of claim 10, wherein determining that the UCIe x64 module supports FLW comprises determining that either one of a first FLW module configuration bit in a Device Vendor Specific Extended Capabilities (DVSEC) Link Capability register of the processor-based device and a second FLW module configuration bit in a physical layer (PHY) control register of the processor-based device is set.

12. The method of claim 11, further comprising, responsive to determining that the UCIe x64 module supports FLW, setting, by the UCIe x64 module, an FLW indication of an MBINIT.PARAM message.

13. The method of claim 10, further comprising, subsequent to determining that the first UCIe x32 module and the second UCIe x32 module require the first x32 link and the second x32 link, respectively:
updating, by the UCIe x64 module, a Device Vendor Specific Extended Capabilities (DVSEC) Link Capability register of the processor-based device to indicate a count of active modules, a configuration of each active module, and a count of die-to-die stacks required to support links between the UCIe x64 module and the first and second UCIe x32 modules; and
configuring, by the UCIe x64 module, a first die-to-die stack and a second die-to-die stack corresponding to the first UCIe x32 module and the second UCIe x32 module, respectively.

14. The method of claim 13, wherein:
the UCIe x64 module comprises a Raw Die-to-Die Interface (RDI) multiplexor configured to arbitrate data transmitted via the first and the second x32 links; and
establishing the data transfer via the first x32 link and the second x32 link comprises establishing data transfer using the RDI multiplexor.

15. The method of claim 10, further comprising:
determining, by the UCIe x64 module during a second initialization of the processor-based device, that the UCIe x64 module is communicatively coupled to a single UCIe x32 module that requires a third x32 link; and
responsive to determining that the UCIe x64 module is communicatively coupled to the single UCIe x32 module:
establishing, by the UCIe x64 module, the third x32 link with the single UCIe x32 module using the plurality of mainband transmit signal lanes including the first 32 bits of the mainband data transmit signal lane, the plurality of mainband receive signal lanes including the first 32 bits of the mainband data receive signal lane, and the plurality of sideband signal lanes; and
establishing, by the UCIe x64 module, data transfer via the third x32 link.

16. The method of claim 10, further comprising:
determining, during a third initialization of the processor-based device, that the UCIe x64 module is communicatively coupled to a single UCIe x64 module that requires an x64 link; and
responsive to determining that the UCIe x64 module is communicatively coupled to the single UCIe x64 module:
establishing, by the UCIe x64 module, the x64 link with the single UCIe x64 module using the plurality of mainband transmit signal lanes including all 64 bits of the mainband data transmit signal lane, the plurality of mainband receive signal lanes including all 64 bits of the mainband data receive signal lane, the plurality of sideband signal lanes, the plurality of redundant mainband transmit signal lanes, the plurality of redundant mainband receive signal lanes, and the plurality of redundant sideband signal lanes; and
establishing, by the UCIe x64 module, data transfer via the x64 link.

17. A non-transitory computer-readable medium, having stored thereon computer-executable instructions that, when executed by a processor device of a processor-based device, cause a Universal Chiplet Interconnect Express (UCIe) 64-bit (x64) module of the processor device to:
determine, during a first initialization of the processor-based device, that the UCIe x64 module supports Flexible Link Width (FLW);
responsive to determining that the UCIe x64 module supports FLW, determine, during the first initialization of the processor-based device, that the UCIe x64 module is communicatively coupled to a first UCIe 32-bit (x32) module and a second UCIe x32 module that require a first x32 link and a second x32 link, respectively; and
responsive to determining that the UCIe x64 module is communicatively coupled to the first UCIe x32 module and the second UCIe x32 module:
establish the first x32 link with the first UCIe x32 module using a plurality of mainband transmit signal lanes including a first 32 bits of a mainband data transmit signal lane, a plurality of mainband receive signal lanes including a first 32 bits of a mainband data receive signal lane, and a plurality of sideband signal lanes;
establish the second x32 link with the second UCIe x32 module using a second 32 bits of the mainband data transmit signal lane, a second 32 bits of the mainband data receive signal lane, a plurality of redundant mainband transmit signal lanes, a plurality of redundant mainband receive signal lanes, and a plurality of redundant sideband signal lanes; and
establish data transfer via the first x32 link and the second x32 link.

18. The non-transitory computer-readable medium of claim 17, wherein the computer-executable instructions cause the UCIe x64 module to determine that the UCIe x64 module supports FLW by causing the UCIe x64 module to determine that either one of a first FLW module configuration bit in a Device Vendor Specific Extended Capabilities (DVSEC) Link Capability register of the processor-based device and a second FLW module configuration bit in a physical layer (PHY) control register of the processor-based device is set.

19. The non-transitory computer-readable medium of claim 18, wherein the computer-executable instructions further cause the UCIe x64 module to, responsive to determining that the UCIe x64 module supports FLW, set an FLW indication of an MBINIT.PARAM message.

20. The non-transitory computer-readable medium of claim 17, wherein the computer-executable instructions further cause the UCIe x64 module to, subsequent to determining that the first UCIe x32 module and the second UCIe x32 module require the first x32 link and the second x32 link, respectively:
update a Device Vendor Specific Extended Capabilities (DVSEC) Link Capability register of the processor-based device to indicate a count of active modules, a configuration of each active module, and a count of die-to-die stacks required to support links between the UCIe x64 module and the first and second UCIe x32 modules; and
configure a first die-to-die stack and a second die-to-die stack corresponding to the first UCIe x32 module and the second UCIe x32 module, respectively.
